(19) United States
(12) Patent Application Publication
(10) Pub. No.: US 2015/0266218 A1
(43) Pub. Date: Sep. 24, 2015

(54) INJECTION MOLDING EQUIPMENT AND INJECTION MOLDING METHOD

(71) Applicant: SINGFORM ENTERPRISE CO., LTD., Chiayi County (TW)

(72) Inventor: Shih-Wen Chen, Chiayi County (TW)

(21) Appl. No.: 14/510,123

(22) Filed: Oct. 9, 2014

(30) Foreign Application Priority Data
Mar. 20, 2014 (TW) 103110564

(51) Int. Cl. B29C 45/04; B29C 45/17; B29C 45/16

(52) U.S. Cl. CPC B29C 45/045; B29C 45/1628; B29C 45/1756; B29C 45/1701; B29K 2009/06

(57) ABSTRACT

An injection molding equipment for continuously manufacturing a plurality of mats includes a conveying mechanism, a plurality of molds, an injection mechanism and a mold opening mechanism. The molds are disposed on a conveying path of the conveying mechanism. The injection mechanism is disposed on the conveying path. The conveying mechanism drives the molds to move along the conveying path and aligns the molds with the injection mechanism sequentially. The injection mechanism injects an injection material into each of the molds, so as to form a mat in each of the molds. The mold opening mechanism is disposed on the conveying path. The conveying mechanism drives the molds to move along the conveying path and aligns the molds with the mold opening mechanism sequentially. The mold opening mechanism opens each of the molds, so as to take out the mat from each of the molds.

### BACKGROUND OF THE INVENTION

1. Field of the Invention

The invention relates to an injection molding equipment and an injection molding method and, more particularly, to an injection molding equipment and an injection molding method for continuously manufacturing a plurality of mats.

2. Description of the Prior Art

Injection molding is a common process for manufacturing plastic products, often used for manufacturing thermoplastic products, and it can be used to manufacture complicated components. Accordingly, the product can be designed freely and the production time can be shortened. That is to say, the injection molding process is suitable for mass production. During the injection molding process, the cooling time is a significant issue for product quality and production speed. However, in the prior art, no matter which type of a mold base is used, the plastic material has to be cooled for a span of time after being injected into the mold base and then the product can be taken out only. Therefore, the cooling time will reduce the production efficiency. In general, the cooling time occupies 40% to 90% of the production time. It is quite serious for a large-sized product (e.g. mat) if the cooling time is too long. If the product is taken out too early, it may deform the product or even damage the product or equipment.

### SUMMARY OF THE INVENTION

An objective of the invention is to provide an injection molding equipment and an injection molding method for continuously manufacturing a plurality of mats, so as to solve the aforesaid problems.

According to an embodiment of the invention, an injection molding equipment for continuously manufacturing a plurality of mats comprises a conveying mechanism, a plurality of molds, an injection mechanism and a mold opening mechanism. The molds are disposed on a conveying path of the conveying mechanism. The injection mechanism is disposed on the conveying path. The conveying mechanism drives the molds to move along the conveying path and aligns the molds with the injection mechanism sequentially. The injection mechanism injects an injection material into each of the molds, so as to form a mat in each of the molds. The mold opening mechanism is disposed on the conveying path. The conveying mechanism drives the molds to move along the conveying path and aligns the molds with the mold opening mechanism sequentially. The mold opening mechanism opens each of the molds, so as to take out the mat from each of the molds.

According to another embodiment of the invention, an injection molding method for continuously manufacturing a plurality of mats comprises steps of disposing a plurality of molds on a conveying path of a conveying mechanism; actuating the conveying mechanism to drive the molds to move along the conveying path; aligning the molds with an injection mechanism sequentially and driving the injection mechanism to inject an injection material into each of the molds, so as to form a mat in each of the molds; and aligning the molds with the mold opening mechanism sequentially and driving the mold opening mechanism to open each of the molds, so as to take out the mat from each of the molds.

According to another embodiment of the invention, an injection molding equipment for continuously manufacturing a plurality of mats comprises a conveying mechanism, a plurality of molds, a mold changing mechanism, a plurality of first upper covers, a plurality of second upper covers, a first injection mechanism, a first mold opening mechanism, a second injection mechanism and a second mold opening mechanism. The molds are disposed on a first conveying path of the conveying mechanism. The mold changing mechanism is adjacent to the conveying mechanism. The first upper covers are disposed on a second conveying path of the mold changing mechanism. The second upper covers are disposed on a third conveying path of the mold changing mechanism. Each of the molds comprises one of the first upper covers or one of the second upper covers. The first injection mechanism is disposed on the first conveying path. The conveying mechanism drives the molds to move along the first conveying path and aligns the molds, which comprise the first upper covers, with the first injection mechanism sequentially. The first injection mechanism injects a first injection material into each of the molds, so as to form a semi-finished product of a mat in each of the molds. The first mold opening mechanism is disposed on the first conveying path. The conveying mechanism drives the molds to move along the first conveying path and aligns the molds, which comprise the first upper covers, with the first mold opening mechanism sequentially. The first mold opening mechanism opens each of the molds, so as to change the first upper cover with the second upper cover. The second injection mechanism is disposed on the first conveying path. The conveying mechanism drives the molds to move along the first conveying path and aligns the molds, which comprise the second upper covers, with the second injection mechanism sequentially. The second injection mechanism injects a second injection material into each of the molds, so as to form the mat in each of the molds. The second mold opening mechanism is disposed on the first conveying path. The conveying mechanism drives the molds to move along the first conveying path and aligns the molds, which comprise the second upper covers, with the second mold opening mechanism sequentially. The second mold opening mechanism opens each of the molds, so as to take out the mat from each of the molds and change the second upper cover with the first upper cover.

According to another embodiment of the invention, an injection molding method for continuously manufacturing a plurality of mats comprises steps of disposing a plurality of molds on a first conveying path of a conveying mechanism, disposing a plurality of first upper covers on a second conveying path of a mold changing mechanism, and disposing a plurality of second upper covers on a third conveying path of the mold changing mechanism, wherein the mold changing mechanism is adjacent to the conveying mechanism and each of the molds comprises one of the first upper covers or one of the second upper covers; actuating the conveying mechanism to drive the molds to move along the first conveying path; aligning the molds, which comprise the first upper covers, with a first injection mechanism sequentially and driving the first injection mechanism to inject a first injection material into each of the molds, so as to form a semi-finished product of a mat in each of the molds; aligning the molds, which comprise the first upper covers, with a first mold opening mechanism sequentially and driving the first mold opening mechanism to open each of the molds, so as to change the first upper cover with the second upper cover; aligning the molds, which comprise the second upper covers, with a second injection mechanism sequentially and driving the second injection mechanism to inject a second injection material into each of the molds, so as to form the mat in each of the molds; and aligning the molds, which comprise the second upper covers, with a second mold opening mechanism sequentially and driving the second mold opening mechanism to open each of the molds, so as to take out the mat from each of the molds and change the second upper cover with the first upper cover.

As mentioned in the above, the invention utilizes the conveying mechanism to drive the molds to move along the conveying path and align each of the molds with the injection mechanism and the mold opening mechanism sequentially. When the mold is aligned with the injection mechanism, the injection mechanism injects the injection material into the mold, so as to form the mat in the mold. After the injection material is injected into the mold, the conveying mechanism drives the mold to move along the conveying path from the injection mechanism to the mold opening mechanism. The injection material in the mold can be cooled while the mold is moving. When the mold is aligned with the mold opening mechanism, the mold opening mechanism opens the mold, so as to take out the mat form the mold. Accordingly, the invention can utilize the conveying mechanism to drive the molds to move along the conveying path and between the injection mechanism and the mold opening mechanism continuously, so as to continuously manufacture a plurality of mats. Since the injection material in the mold can be cooled while the mold is moving, the invention can avoid reducing the production efficiency, resulting from the cooling time. Furthermore, the invention can utilize at least two injection mechanisms and at least two mold opening mechanisms to cooperate with each other to inject different injection materials into the mold in different processes, so as to manufacture the mats with various material characteristics, shapes, patterns, colors and so on. Therefore, the mats manufactured by the invention can satisfy different requirements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic side view illustrating an injection molding equipment according to an embodiment of the invention.

FIG. 2 is a schematic top view illustrating the conveying mechanism, the injection mechanism and the mold opening mechanism shown in FIG. 1.

FIG. 3 is a schematic top view illustrating a plurality of molds disposed on the corresponding through holes of the conveying mechanism shown in FIG. 2.

FIG. 4 is a schematic side view illustrating the mold not opened by the mold opening mechanism shown in FIG. 1.

FIG. 5 is a schematic side view illustrating the mold opened by the mold opening mechanism shown in FIG. 1.

FIG. 6 is a schematic view illustrating a mat manufactured by the injection molding equipment shown in FIG. 1.

FIG. 7 is a flowchart illustrating an injection molding method according to an embodiment of the invention.

FIG. 8 is a schematic top view illustrating an injection molding equipment according to another embodiment of the invention.

FIG. 9 is a schematic view illustrating a mat manufactured by the injection molding equipment shown in FIG. 8.

FIG. 10 is a flowchart illustrating an injection molding method according to another embodiment of the invention.

### DETAILED DESCRIPTION

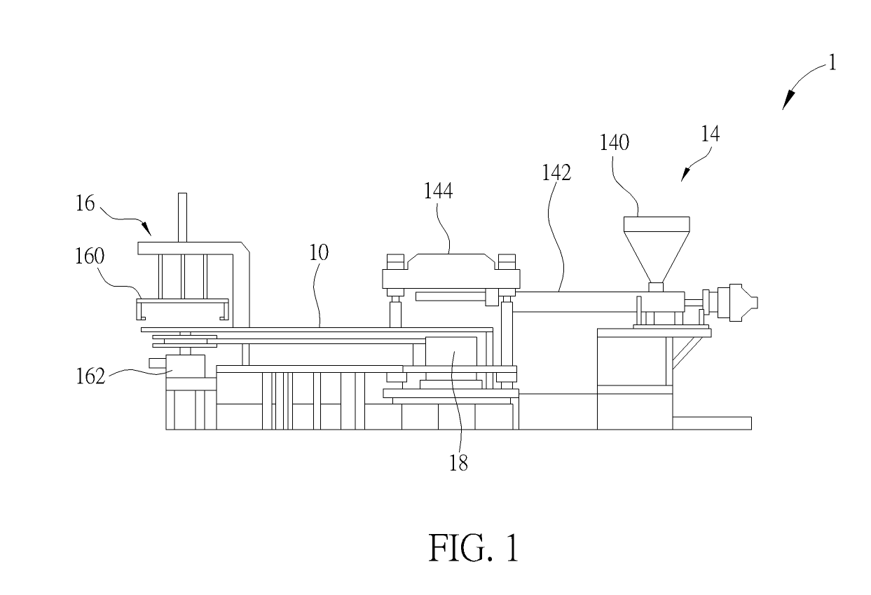

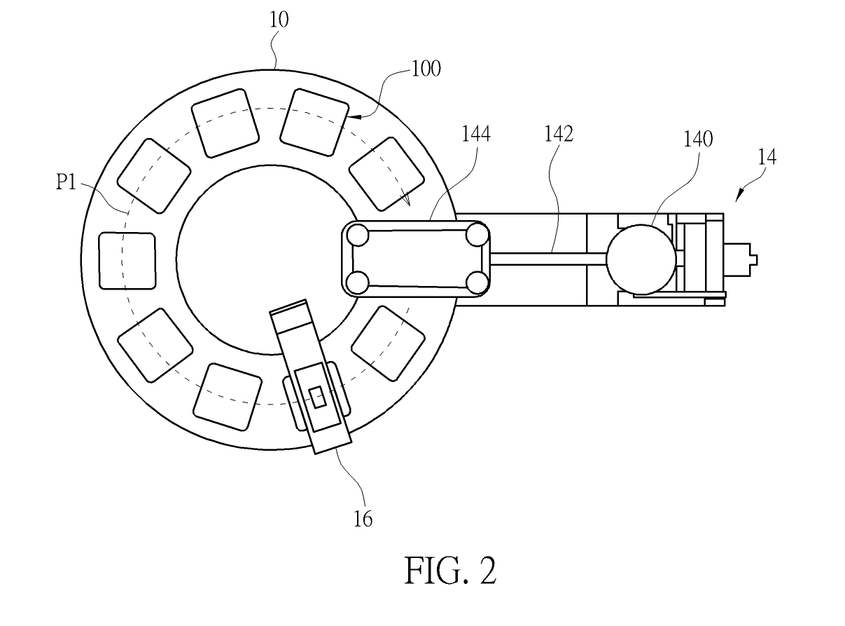

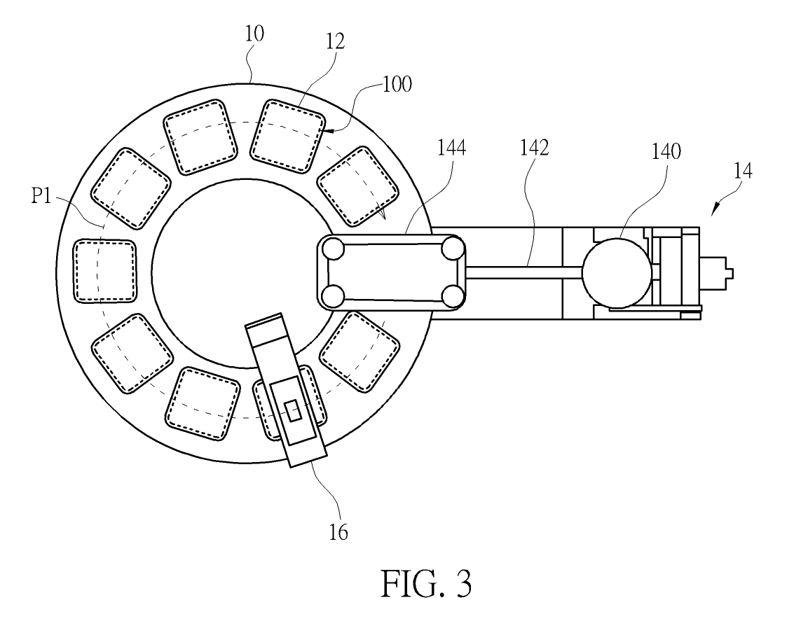

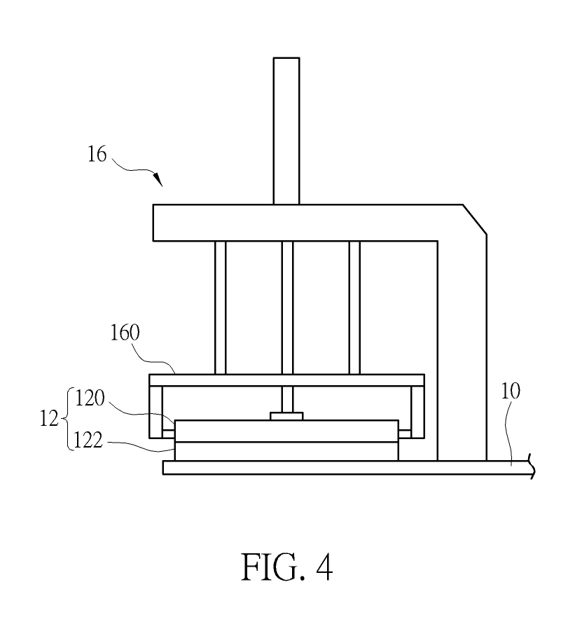

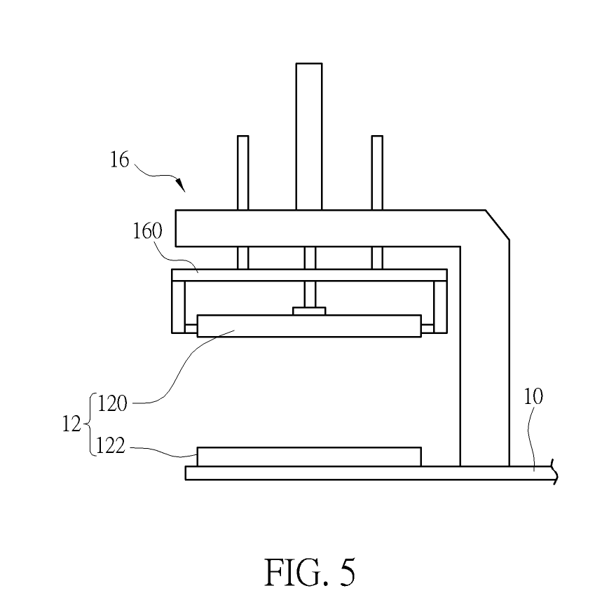

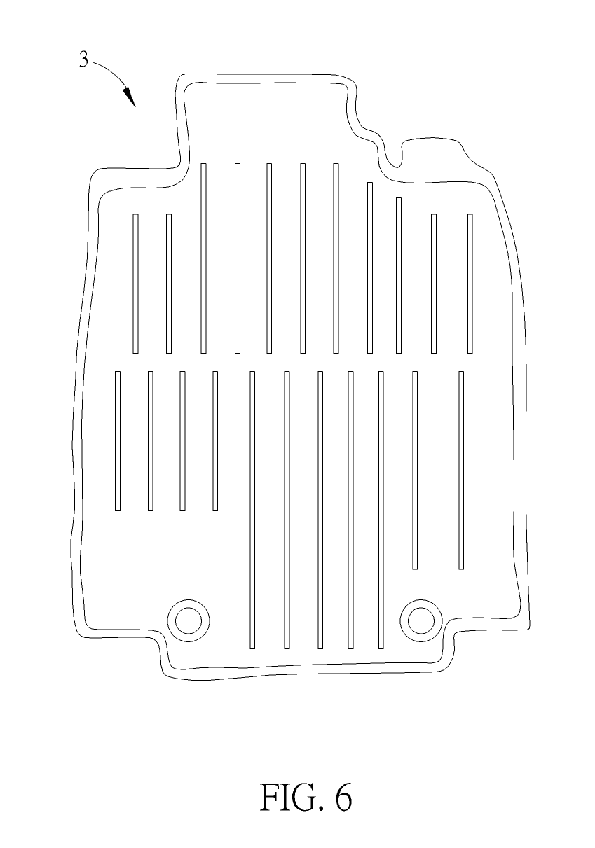

Referring to FIGS. 1 to 6, FIG. 1 is a schematic side view illustrating an injection molding equipment 1 according to an embodiment of the invention, FIG. 2 is a schematic top view illustrating the conveying mechanism 10, the injection mechanism 14 and the mold opening mechanism 16 shown in FIG. 1, FIG. 3 is a schematic top view illustrating a plurality of molds 12 disposed on the corresponding through holes 100 of the conveying mechanism 10 shown in FIG. 2, FIG. 4 is a schematic side view illustrating the mold 12 not opened by the mold opening mechanism 16 shown in FIG. 1, FIG. 5 is a schematic side view illustrating the mold 12 opened by the mold opening mechanism 16 shown in FIG. 1, and FIG. 6 is a schematic view illustrating a mat 3 manufactured by the injection molding equipment 1 shown in FIG. 1. The injection molding equipment 1 shown in FIG. 1 can be used for manufacturing a plurality of mats 3 shown in FIG. 6. It should be noted that the shape, pattern, color and so on of the mat 3 can be designed according to practical applications and are not limited in the embodiment shown in FIG. 6. Preferably, the mat 3 may be, but not limited to, a vehicle mat. In other words, in addition to the vehicle mat, the injection molding equipment 1 of the invention may also be used for manufacturing a plurality of other mats, such as safety mat, foot mat, skidproof mat and so on.

As shown in FIGS. 1 to 3, the injection molding equipment 1 comprises a conveying mechanism 10, a plurality of molds 12, an injection mechanism 14, a mold opening mechanism 16 and an auxiliary mechanism 18. The molds 12 are disposed on a conveying path P1 of the conveying mechanism 10. In this embodiment, the conveying path P1 is, but not limited to, circular. In another embodiment, the conveying path P1 may also be oval-shaped, rectangular or polygonal according to practical applications. The conveying mechanism 10 may be a rotating platform driven by a driving device (e.g. motor) to rotate. Furthermore, the injection mechanism 14 and the mold opening mechanism 16 both are disposed on the conveying path P1 of the conveying mechanism 10. Accordingly, when the conveying mechanism 10 rotates, it can drive the molds 12 to move along the conveying path P1 and align each of the molds 12 with the injection mechanism 14 and the mold opening mechanism 16. In this embodiment, the molds 12 may be disposed on the conveying path P1 of the conveying mechanism 10 separately in equal distance, but the invention is not limited to this embodiment.

When the conveying mechanism 10 drives the molds 12 to move along the conveying path P1 and aligns the molds 12 with the injection mechanism 14, the injection mechanism 14 can inject an injection material (not shown) into each of the molds 12, so as to form a mat 3 in each of the molds 12. In this embodiment, the injection mechanism 14 may comprise a feeding section 140, a processing section 142 and an injecting section 144, wherein the processing section 142 is connected to the feeding section 140 and the injecting section 144. The aforesaid injection material is injected into the processing section 142 through the feeding section 140. The processing section 142 processes the injection material by melting, mixing and other processes and then the injecting section 144 injects the injection material into the mold 12.

In this embodiment, the aforesaid injection material may be a compound of styrene-ethylene/butylene-styrene block copolymer (SEBS), styrene-butadiene-styrene block copolymer (SBS), polypropylene (PP) and functional additive, wherein a weight percentage of the SEBS may be between 20 wt % and 30 wt %, a weight percentage of the SBS may be between 40 wt % and 50 wt %, a weight percentage of the PP may be between 20 wt % and 30 wt %, and a weight percentage of the functional additive may be 20 wt %. Furthermore, the aforesaid functional additive may comprise light stabilizer, antioxidants, calcium carbonate and processing oil, wherein the light stabilizer can improve aging crack and light fastness and the antioxidants can prevent the injection material from being affected by the processing temperature. It should be noted that the invention may also take other materials to be the aforesaid injection material according to practical applications, so the invention is not limited to the aforesaid embodiment.

As shown in FIG. 4, each of the molds 12 may comprise an upper cover 120 and a mold base 122, wherein the upper cover 120 is detachably disposed on the mold base 122. When performing injection molding, the upper cover 120 is combined with the mold base 122 tightly. Furthermore, when the mold 12 is aligned with the injection mechanism 14, the injecting section 144 of the injection mechanism 14 can be connected to the mold 12, such that the injecting section 144 of the injection mechanism 14 can inject the injection material into the mold 12 through an injection inlet (not shown) formed on the mold 12, so as to form the mat 3 in the mold 12. The aforesaid injection inlet may be formed on the upper cover 120 or other portions of the mold 12 according to practical applications.

In this embodiment, the invention may utilize the auxiliary mechanism 18 shown in FIG. 1 to assist the injection inlet of the mold 12 in connecting with an injection outlet of the injecting section 144 of the injection mechanism 14 and vacuumize the mold 12, such that the injection material can distribute and flow in the mold 12 uniformly. After the injection material is injected into the mold 12, the auxiliary mechanism 18 can assist the mold 12 in coming off the injecting section 144 of the injection mechanism 14 and break vacuum for the mold 12. In this embodiment, the conveying mechanism 10 may have a plurality of through holes 100 and each of the molds 12 may be disposed on one of the through holes 100, as shown in FIGS. 2 and 3. Accordingly, the auxiliary mechanism 18 can pass through the through hole 100 to lift and lower the mold 12, so as to assist the mold 12 in connecting with or coming off the injecting section 144 of the injection mechanism 14. For example, the auxiliary mechanism 18 may vacuumize the mold 12 first and then lift the mold 12 to the position of the injection outlet of the injecting section 144 of the injection mechanism 14 from bottom to top, so as to enable the injection inlet of the mold 12 and the injection outlet of the injecting section 144 of the injection mechanism 14 to communicate with each other, such that the injection material can be injected into the mold 12. The invention may form a hole (not shown) on a surface of the mold 12 and connect a vacuum pump to the hole, so as to utilize the vacuum pump to vacuumize the mold 12.

After the injection mechanism 14 injects the injection material into the mold 12, the conveying mechanism 10 will drive the mold 12 to move along the conveying path P1 from the injection mechanism 14 to the mold opening mechanism 16 and align the mold 12 with the mold opening mechanism 16. The injection material in the mold 12 can be cooled while the mold 12 is moving. When the mold 12 is aligned with the mold opening mechanism 16, the mold opening mechanism 16 opens the mold 12, so as to take out the mat 3 form the mold 12.

As shown in FIGS. 4 and 5, when the mold 12 is aligned with the mold opening mechanism 16, the mold opening mechanism 16 may utilize a mold opening device 160 to detach the upper cover 120 of the mold 12 from the mold base 122. After the upper cover 120 of the mold 12 is detached from the mold base 122, the mold opening mechanism 16 utilizes a mold ejecting device 162 to eject the mat 3, which has been cooled and shaped, out of the mold 12. The mold opening device 160 and the upper cover 120 of the mold 12 may be designed in corresponding manners, such that the mold opening device 160 can lift the upper cover 120 of the mold 12 rapidly. In this embodiment, the mold opening device 160 may be a lift device (e.g. robot arm), a hanging device or an overhead crane.

Accordingly, the invention can utilize the conveying mechanism 10 to drive the molds 12 to move along the conveying path P1 and between the injection mechanism 14 and the mold opening mechanism 16 continuously, so as to continuously manufacture a plurality of mats 3. Since the injection material in the mold 12 can be cooled while the mold 12 is moving, the invention can avoid reducing the production efficiency, resulting from the cooling time.

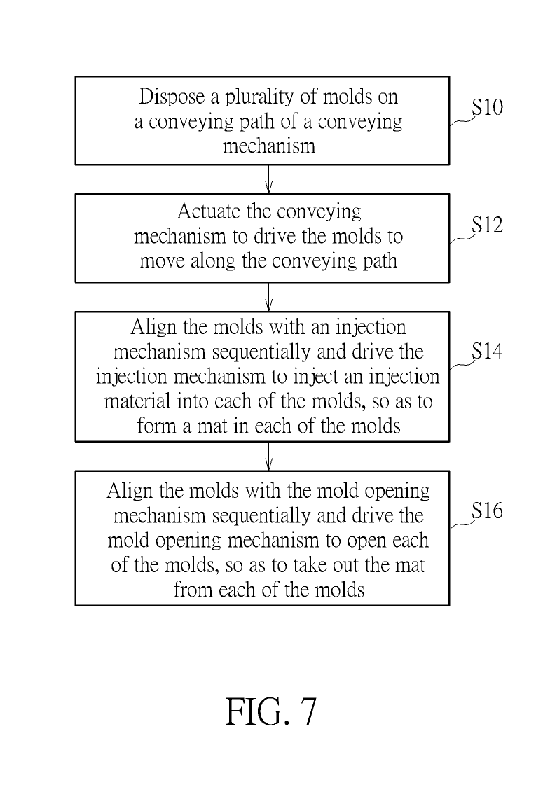

Referring to FIG. 7, FIG. 7 is a flowchart illustrating an injection molding method according to an embodiment of the invention. The injection molding method shown in FIG. 7 may be implemented by the injection molding equipment 1 shown in FIG. 1. First of all, step S10 is performed to dispose a plurality of molds 12 on a conveying path P1 of a conveying mechanism 10. Afterward, step S12 is performed to actuate the conveying mechanism 10 to drive the molds 12 to move along the conveying path P1. Then, step S14 is performed to align the molds 12 with an injection mechanism 14 sequentially and drive the injection mechanism 14 to inject an injection material into each of the molds 12, so as to form a mat 3 in each of the molds 12. Finally, step S16 is performed to align the molds 12 with the mold opening mechanism 16 sequentially and drive the mold opening mechanism 16 to open each of the molds 12, so as to take out the mat 3 from each of the molds 12. Accordingly, the invention can continuously manufacturing a plurality of mats 3. It should be noted that the invention will vacuumize the mold 12 before the injection material is injected into the mold 12 and breaks vacuum for the mold 12 after the injection material is injected into the mold 12. Furthermore, the other operation principles of the injection molding method of the invention have been depicted in the above and will not be depicted herein again.

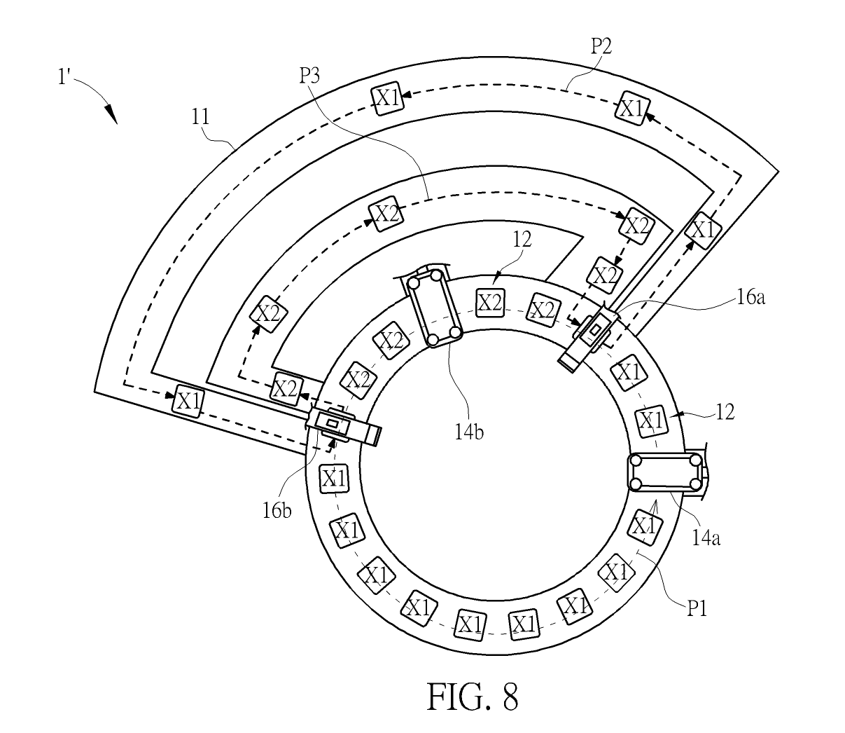

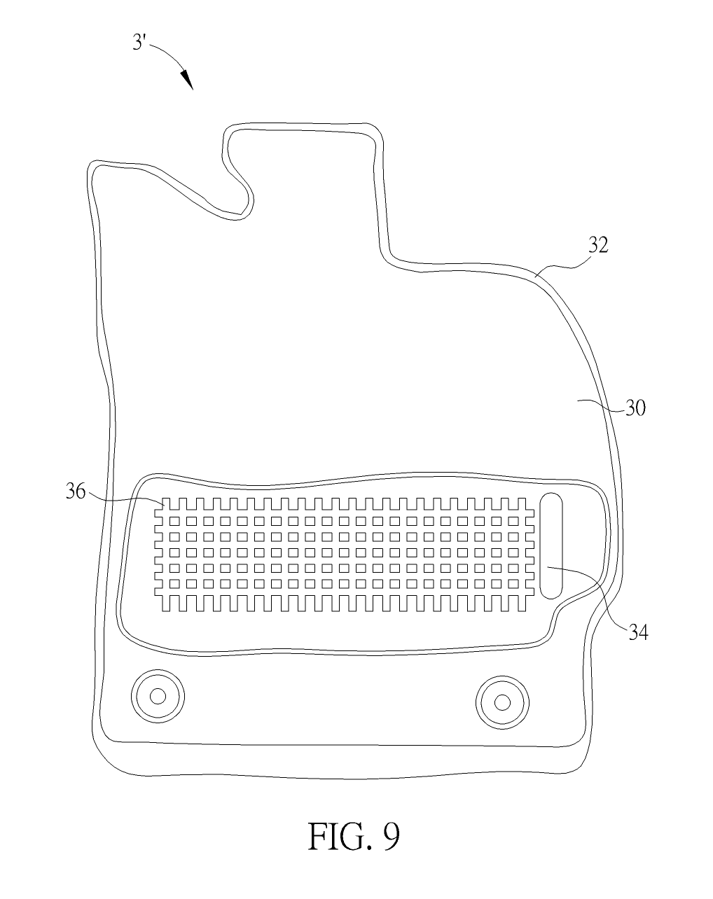

Referring to FIGS. 8 and 9, FIG. 8 is a schematic top view illustrating an injection molding equipment 1′ according to another embodiment of the invention, and FIG. 9 is a schematic view illustrating a mat 3′ manufactured by the injection molding equipment 1′ shown in FIG. 8. The injection molding equipment 1′ shown in FIG. 8 can be used for manufacturing a plurality of mats 3′ shown in FIG. 9. It should be noted that the shape, pattern, color and so on of the mat 3′ can be designed according to practical applications and are not limited in the embodiment shown in FIG. 9. Preferably, the mat 3′ may be, but not limited to, a vehicle mat. In other words, in addition to the vehicle mat, the injection molding equipment 1′ of the invention may also be used for manufacturing a plurality of other mats, such as safety mat, foot mat, skidproof mat and so on.

The main difference between the injection molding equipment 1′ and the aforesaid injection molding equipment 1 is that the injection molding equipment 1′ further comprises a mold changing mechanism 11, a plurality of first upper covers X1, a plurality of second upper covers X2, a first injection mechanism 14a, a first mold opening mechanism 16a, a second injection mechanism 14b and a second mold opening mechanism 16b. The mold changing mechanism 11 is adjacent to the conveying mechanism 10. The molds 12 are disposed on a first conveying path P1 of the conveying mechanism 10, the first upper covers X1 are disposed on a second conveying path P2 of the mold changing mechanism 11 and the second upper covers X2 are disposed on a third conveying path P3 of the mold changing mechanism 11. In this embodiment, each of the molds 12 comprises one of the first upper covers X1 or one of the second upper covers X2. Furthermore, each of the molds 12 further comprises the aforesaid mold base 122 (not shown in FIG. 8) and the first upper cover X1 or the second upper cover X2 is detachably disposed on the mold base 122.

In this embodiment, the conveying mechanism 10 can drive the molds 12 disposed thereon to move along the first conveying path P1 and the mold changing mechanism 11 can drive the first upper covers X1 and the second upper covers X2 disposed thereon to move along the second conveying path P2 and the third conveying path P3, respectively. In this embodiment, the first conveying path P1 is, but not limited to, circular and the second conveying path P2 and the third conveying path P3 are, but not limited to, fan-shaped. In another embodiment, the first conveying path P1 may also be oval-shaped, rectangular or polygonal, and the second conveying path P2 and the third conveying path P3 may also be polygonal according to practical applications. Furthermore, the first injection mechanism 14a, the first mold opening mechanism 16a, the second injection mechanism 14b and the second mold opening mechanism 16b all are disposed on the first conveying path P1 of the conveying mechanism 10. Accordingly, when the conveying mechanism 10 rotates, it can drive the molds 12 disposed thereon to move along the first conveying path P1 and align each of molds 12 with the first injection mechanism 14a, the first mold opening mechanism 16a, the second injection mechanism 14b and the second mold opening mechanism 16b sequentially.

When the conveying mechanism 10 drives the molds 12 to move along the first conveying path P1 and aligns the molds 12, which comprise the first upper covers X1, with the first injection mechanism 14a sequentially, the first injection mechanism 14a injects a first injection material (not shown) into each of the molds 12, so as to form a semi-finished product of a mat 3′ in each of the molds 12. Afterward, when the conveying mechanism 10 drives the molds 12 to move along the first conveying path P1 and aligns the molds 12, which comprise the first upper covers X1, with the first mold opening mechanism 16a sequentially, the first mold opening mechanism 16a opens each of the molds 12, so as to change the first upper cover X1 with the second upper cover X2. Then, when the conveying mechanism 10 drives the molds 12 to move along the first conveying path P1 and aligns the molds 12, which comprise the second upper covers X2, with the second injection mechanism 14b sequentially, the second injection mechanism 14b injects a second injection material (not shown) into each of the molds 12, so as to form the mat 3′ in each of the molds 12. Then, when the conveying mechanism 10 drives the molds 12 to move along the first conveying path P1 and aligns the molds 12, which comprise the second upper covers X2, with the second mold opening mechanism 16b sequentially, the second mold opening mechanism 16b opens each of the molds 12, so as to take out the mat 3′ from each of the molds 12 and change the second upper cover X2 with the first upper cover X1 for next injection molding process.

It should be noted that the operation principles of the first injection mechanism 14a and the second injection mechanism 14b are substantially the same as the operation principle of the aforesaid injection mechanism 14, the operation principles of the first mold opening mechanism 16a and the second mold opening mechanism 16b are substantially the same as the operation principle of the aforesaid mold opening mechanism 16, the first injection material and the second injection material can be obtained according to the aforesaid injection material, so those will not be depicted herein again. The invention can utilize the first injection mechanism 14a and the second injection mechanism 14b along with the first upper cover X1 and the second upper cover X2 to inject the first injection material and the second injection material with different characteristics, colors and/or structures, such that the mat 3′ can satisfy different requirements.

As shown in FIG. 9, the mat 3′ may comprise a base structure 30, an edge structure 32, a tag structure 34 and/or a specific function structure 36, wherein the specific function structure 36 may have skidproof function, cleaning function, wearproof function and so on. For example, the first injection mechanism 14a injects the first injection material into the mold 12, which comprises the first upper cover X1, so as to form the base structure 30 of the mat 3′. Afterward, the second injection mechanism 14b injects the second injection material into the mold 12, which comprises the second upper cover X2, so as to form the edge structure 32, the tag structure 34 and the specific function structure 36 of the mat 3′. Accordingly, the mat 3′ is finished. In other words, the invention can utilize at least two injection mechanisms and at least two mold opening mechanisms to cooperate with each other to inject different injection materials into the mold in different processes, so as to manufacture the mats with various material characteristics, shapes, patterns, colors and so on. Therefore, the mats manufactured by the invention can satisfy different requirements.

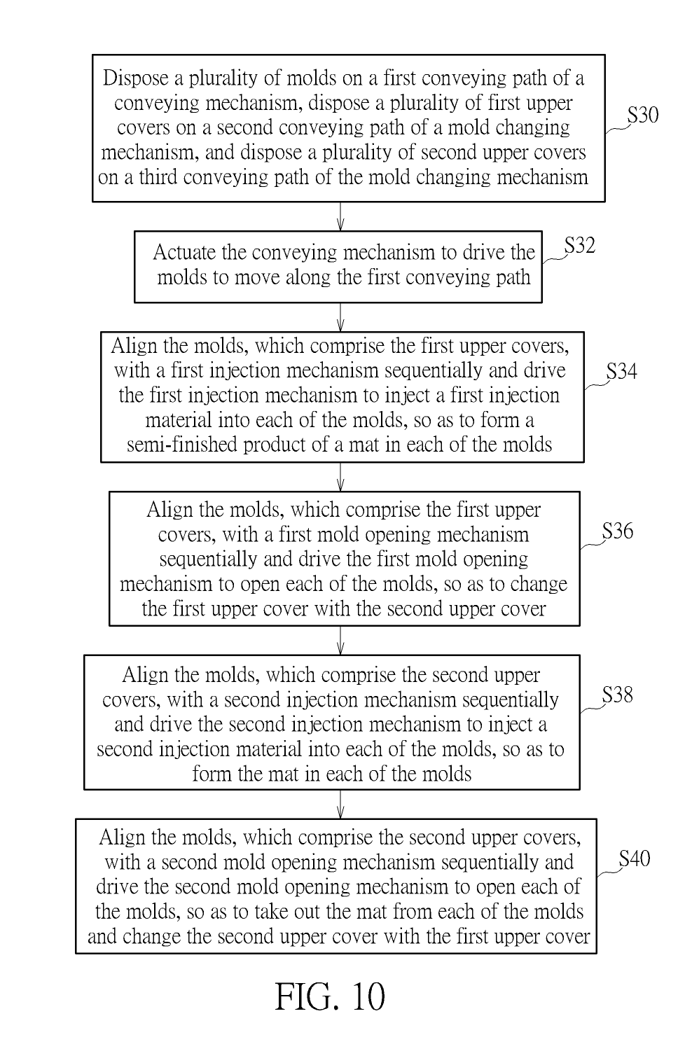

Referring to FIG. 10, FIG. 10 is a flowchart illustrating an injection molding method according to another embodiment of the invention. The injection molding method shown in FIG. 10 may be implemented by the injection molding equipment 1′ shown in FIG. 8. First of all, step S30 is performed to dispose a plurality of molds 12 on a first conveying path P1 of a conveying mechanism 10, dispose a plurality of first upper covers X1 on a second conveying path P2 of a mold changing mechanism 11, and dispose a plurality of second upper covers X2 on a third conveying path P3 of the mold changing mechanism 11. Afterward, step S32 is performed to actuate the conveying mechanism 10 to drive the molds 12 to move along the first conveying path P1. Then, step S34 is performed to align the molds 12, which comprise the first upper covers X1, with a first injection mechanism 14a sequentially and drive the first injection mechanism 14a to inject a first injection material into each of the molds 12, so as to form a semi-finished product of a mat 3′ in each of the molds 12. Then, step S36 is performed to align the molds 12, which comprise the first upper covers X1, with a first mold opening mechanism 16a sequentially and drive the first mold opening mechanism 16a to open each of the molds 12, so as to change the first upper cover X1 with the second upper cover X2. Then, step S38 is performed to align the molds 12, which comprise the second upper covers X2, with a second injection mechanism 14b sequentially and drive the second injection mechanism 14b to inject a second injection material into each of the molds 12, so as to form the mat 3′ in each of the molds 12. Finally, step S40 is performed to align the molds 12, which comprise the second upper covers X2, with a second mold opening mechanism 16b sequentially and drive the second mold opening mechanism 16b to open each of the molds 12, so as to take out the mat 3′ from each of the molds 12 and change the second upper cover X2 with the first upper cover X1. Accordingly, the invention can continuously manufacturing a plurality of mats 3′. It should be noted that the invention will vacuumize the mold 12 before the first injection material or the second injection material is injected into the mold 12 and breaks vacuum for the mold 12 after the first injection material or the second injection material is injected into the mold 12. Furthermore, the other operation principles of the injection molding method of the invention have been depicted in the above and will not be depicted herein again.

As mentioned in the above, the invention utilizes the conveying mechanism to drive the molds to move along the conveying path and align each of the molds with the injection mechanism and the mold opening mechanism sequentially. When the mold is aligned with the injection mechanism, the injection mechanism injects the injection material into the mold, so as to form the mat in the mold. After the injection material is injected into the mold, the conveying mechanism drives the mold to move along the conveying path from the injection mechanism to the mold opening mechanism. The injection material in the mold can be cooled while the mold is moving. When the mold is aligned with the mold opening mechanism, the mold opening mechanism opens the mold, so as to take out the mat form the mold. Accordingly, the invention can utilize the conveying mechanism to drive the molds to move along the conveying path and between the injection mechanism and the mold opening mechanism continuously, so as to continuously manufacture a plurality of mats. Since the injection material in the mold can be cooled while the mold is moving, the invention can avoid reducing the production efficiency, resulting from the cooling time. Furthermore, the invention can utilize at least two injection mechanisms and at least two mold opening mechanisms to cooperate with each other to inject different injection materials into the mold in different processes, so as to manufacture the mats with various material characteristics, shapes, patterns, colors and so on. Therefore, the mats manufactured by the invention can satisfy different requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An injection molding equipment for continuously manufacturing a plurality of mats comprising:
a conveying mechanism;
a plurality of molds disposed on a conveying path of the conveying mechanism;
an injection mechanism disposed on the conveying path, the conveying mechanism driving the molds to move along the conveying path and aligning the molds with the injection mechanism sequentially, the injection mechanism injecting an injection material into each of the molds, so as to form a mat in each of the molds; and
a mold opening mechanism disposed on the conveying path, the conveying mechanism driving the molds to move along the conveying path and aligning the molds with the mold opening mechanism sequentially, the mold opening mechanism opening each of the molds, so as to take out the mat from each of the molds.

2. The injection molding equipment of claim 1, wherein each of the molds comprises an upper cover and a mold base, and the upper cover is detachably disposed on the mold base.

3. The injection molding equipment of claim 1, wherein the injection mechanism comprises a feeding section, a processing section and an injecting section, the processing section is connected to the feeding section and the injecting section, the injection material is injected into the processing section through the feeding section, the processing section processes the injecting section, and the injecting section injects the injection material into the mold.

4. The injection molding equipment of claim 3, further comprising an auxiliary mechanism, wherein the auxiliary mechanism assists the mold in connecting with the injecting section of the injection mechanism and vacuumizes the mold; and after the injection material is injected into the mold, the auxiliary mechanism assists the mold in coming off the injecting section of the injection mechanism and breaks vacuum for the mold.

5. The injection molding equipment of claim 4, wherein the conveying mechanism has a plurality of through holes, each of the molds is disposed on one of the through holes, and the auxiliary mechanism passes through the through hole to lift or lower the mold.

6. The injection molding equipment of claim 1, wherein the conveying path is circular.

7. The injection molding equipment of claim 1, wherein the injection material is a compound of styrene-ethylene/butylene-styrene block copolymer (SEBS), styrene-butadiene-styrene block copolymer (SBS), polypropylene (PP) and functional additive.

8. The injection molding equipment of claim 7, wherein a weight percentage of the SEBS is between 20 wt % and 30 wt %, a weight percentage of the SBS is between 40 wt % and 50 wt %, a weight percentage of the PP is between 20 wt % and 30 wt %, and a weight percentage of the functional additive is 20 wt %.

9. The injection molding equipment of claim 7, wherein the functional additive comprises light stabilizer, antioxidants, calcium carbonate and processing oil.

10. An injection molding method for continuously manufacturing a plurality of mats comprising:
disposing a plurality of molds on a conveying path of a conveying mechanism;
actuating the conveying mechanism to drive the molds to move along the conveying path;
aligning the molds with an injection mechanism sequentially and driving the injection mechanism to inject an injection material into each of the molds, so as to form a mat in each of the molds; and
aligning the molds with the mold opening mechanism sequentially and driving the mold opening mechanism to open each of the molds, so as to take out the mat from each of the molds.

11. The injection molding method of claim 10, further comprising:
vacuumizing the mold before the injection material is injected into the mold; and
breaking vacuum for the mold after the injection material is injected into the mold.

12. The injection molding method of claim 10, wherein the injection material is a compound of styrene-ethylene/butylene-styrene block copolymer (SEBS), styrene-butadiene-styrene block copolymer (SBS), polypropylene (PP) and functional additive.

13. The injection molding method of claim 12, wherein a weight percentage of the SEBS is between 20 wt % and 30 wt %, a weight percentage of the SBS is between 40 wt % and 50 wt %, a weight percentage of the PP is between 20 wt % and 30 wt %, and a weight percentage of the functional additive is 20 wt %.

14. The injection molding method of claim 12, wherein the functional additive comprises light stabilizer, antioxidants, calcium carbonate and processing oil.

15. An injection molding equipment for continuously manufacturing a plurality of mats comprising:
a conveying mechanism;
a plurality of molds disposed on a first conveying path of the conveying mechanism;
a mold changing mechanism adjacent to the conveying mechanism;
a plurality of first upper covers disposed on a second conveying path of the mold changing mechanism;
a plurality of second upper covers disposed on a third conveying path of the mold changing mechanism, each of the molds comprises one of the first upper covers or one of the second upper covers;
a first injection mechanism disposed on the first conveying path, the conveying mechanism driving the molds to move along the first conveying path and aligning the molds, which comprise the first upper covers, with the first injection mechanism sequentially, the first injection mechanism injecting a first injection material into each of the molds, so as to form a semi-finished product of a mat in each of the molds;
a first mold opening mechanism disposed on the first conveying path, the conveying mechanism driving the molds to move along the first conveying path and aligning the molds, which comprise the first upper covers, with the first mold opening mechanism sequentially, the first mold opening mechanism opening each of the molds, so as to change the first upper cover with the second upper cover;
a second injection mechanism disposed on the first conveying path, the conveying mechanism driving the molds to move along the first conveying path and aligning the molds, which comprise the second upper covers, with the second injection mechanism sequentially, the second injection mechanism injecting a second injection material into each of the molds, so as to form the mat in each of the molds; and
a second mold opening mechanism disposed on the first conveying path, the conveying mechanism driving the molds to move along the first conveying path and aligning the molds, which comprise the second upper covers, with the second mold opening mechanism sequentially, the second mold opening mechanism opening each of the molds, so as to take out the mat from each of the molds and change the second upper cover with the first upper cover.

16. The injection molding equipment of claim 15, wherein each of the molds further comprises a mold base, and the first upper cover or the second upper cover is detachably disposed on the mold base.

17. The injection molding equipment of claim 15, wherein each of the first injection mechanism and the second injection mechanism comprises a feeding section, a processing section and an injecting section, the processing section is connected to the feeding section and the injecting section, the first injection material and the second injection material are inj ected into the processing section through the feeding section, the processing section processes the first injecting section and the second injection material, and the injecting section injects the first injection material and the second injection material into the mold.

18. The injection molding equipment of claim 17, further comprising an auxiliary mechanism, wherein the auxiliary mechanism assists the mold in connecting with the injecting section of the first injection mechanism or the second injection mechanism and vacuumizes the mold; and after the first injection material or the second injection material is injected into the mold, the auxiliary mechanism assists the mold in coming off the injecting section of the first injection mechanism or the second injection mechanism and breaks vacuum for the mold.

19. The injection molding equipment of claim 18, wherein the conveying mechanism has a plurality of through holes, each of the molds is disposed on one of the through holes, and the auxiliary mechanism passes through the through hole to lift or lower the mold.

20. The injection molding equipment of claim 15, wherein the first conveying path is circular, and the second conveying path and the third conveying path are fan-shaped.

21. The injection molding equipment of claim 15, wherein the first injection material and the second injection material are compounds of styrene-ethylene/butylene-styrene block copolymer (SEBS), styrene-butadiene-styrene block copolymer (SBS), polypropylene (PP) and functional additive.

22. The injection molding equipment of claim 21, wherein a weight percentage of the SEBS is between 20 wt % and 30 wt %, a weight percentage of the SBS is between 40 wt % and 50 wt %, a weight percentage of the PP is between 20 wt % and 30 wt %, and a weight percentage of the functional additive is 20 wt %.

23. The injection molding equipment of claim 21, wherein the functional additive comprises light stabilizer, antioxidants, calcium carbonate and processing oil.

24. An injection molding method for continuously manufacturing a plurality of mats comprising:
disposing a plurality of molds on a first conveying path of a conveying mechanism, disposing a plurality of first upper covers on a second conveying path of a mold changing mechanism, and disposing a plurality of second upper covers on a third conveying path of the mold changing mechanism, wherein the mold changing mechanism is adjacent to the conveying mechanism and each of the molds comprises one of the first upper covers or one of the second upper covers;
actuating the conveying mechanism to drive the molds to move along the first conveying path;
aligning the molds, which comprise the first upper covers, with a first injection mechanism sequentially and driving the first injection mechanism to inject a first injection material into each of the molds, so as to form a semi-finished product of a mat in each of the molds;
aligning the molds, which comprise the first upper covers, with a first mold opening mechanism sequentially and driving the first mold opening mechanism to open each of the molds, so as to change the first upper cover with the second upper cover;
aligning the molds, which comprise the second upper covers, with a second injection mechanism sequentially and driving the second injection mechanism to inject a second injection material into each of the molds, so as to form the mat in each of the molds; and
aligning the molds, which comprise the second upper covers, with a second mold opening mechanism sequentially and driving the second mold opening mechanism to open each of the molds, so as to take out the mat from each of the molds and change the second upper cover with the first upper cover.

25. The injection molding method of claim 24, further comprising:
vacuumizing the mold before the first injection material or the second injection material is injected into the mold; and
breaking vacuum for the mold after the first injection material or the second injection material is injected into the mold.

26. The injection molding method of claim 24, wherein the first injection material and the second injection material are compounds of styrene-ethylene/butylene-styrene block copolymer (SEBS), styrene-butadiene-styrene block copolymer (SBS), polypropylene (PP) and functional additive.

27. The injection molding method of claim 26, wherein a weight percentage of the SEBS is between 20 wt % and 30 wt %, a weight percentage of the SBS is between 40 wt % and 50 wt %, a weight percentage of the PP is between 20 wt % and 30 wt %, and a weight percentage of the functional additive is 20 wt %.

28. The injection molding method of claim 26, wherein the functional additive comprises light stabilizer, antioxidants, calcium carbonate and processing oil.
